(19) United States
(12) Patent Application Publication
(10) Pub. No.: US 2026/0094411 A1
(43) Pub. Date: Apr. 2, 2026

(54) PRODUCT IDENTIFICATION SYSTEMS AND METHODS

(71) Applicant: PepsiCo, Inc., Purchase, NY (US)

(72) Inventors: Minjun HUANG, Valhalla, NY (US); Terry Tae-il CHUNG, New Fairfield, CT (US)

(21) Appl. No.: 18/900,147

(22) Filed: Sep. 27, 2024

(51) Int. Cl. G06V 10/764; G06V 10/20; G06V 10/40

(52) U.S. Cl. CPC G06V 10/764; G06V 10/255; G06V 10/40

(57) ABSTRACT

Embodiments described herein relate to vending systems that allow a customer to directly remove and handle products before purchasing. Systems described herein can include cameras that can capture images of products stored in, removed from, or returned to the vending system. Based on these images, the system can both determine the identity of the product and the temperature of the product. This can help with inventory tracking, quality control, and preventing unauthorized activity related to the vending system.

### BACKGROUND

Embodiments described herein generally related to unattended vending and dispensing systems. Specifically, embodiments described herein related to system and methods for identifying products stored in, removed from, and/or returned to an unattended vending system based on various characteristics (e.g., size, shape, color, etc.) and determining the temperature of the products.

### BRIEF SUMMARY

Some embodiments are directed to a method for identifying characteristics of products in a cabinet that includes detecting a first characteristic of a first product stored in a storage area of the cabinet, wherein the product storage area is accessible to a consumer via a door, wherein the first characteristic is detected by a camera within the cabinet, wherein the first characteristic comprises a shape of the product, a dimension of the product, or a coloring of the product; detecting a second characteristic of the first product by the camera, wherein the second characteristic comprises infrared energy; determining, based on the detected first characteristic, an identity of the product; determining, based on the detected second characteristic, a temperature of the product.

In any of the various embodiments discussed herein, the first characteristic and the second characteristic are detected at a first time period corresponding to the product being removed from the storage area.

In any of the various embodiments discussed herein, the method further includes determining the temperature of the product at the first time period.

In any of the various embodiments discussed herein, the method further includes notifying the consumer, on a display of the cabinet, when the temperature of the product at the first time period is greater than a predetermined temperature.

In any of the various embodiments discussed herein, the first characteristic and the second characteristic are detected at a second time period corresponding to the product being returned to the storage area.

In any of the various embodiments discussed herein, the method further includes determining the temperature of the product at the second time period and comparing the temperature at the first time period and temperature at the second time period to determine a difference in temperature.

In any of the various embodiments discussed herein, the method further includes notifying the consumer, on a display of the cabinet, when the difference in temperature is greater than 10° C.

In any of the various embodiments discussed herein, the method further includes charging the consumer, on a payment processing unit, for the product when the difference in temperature is greater than 10° C.

In any of the various embodiments discussed herein, the determining the identity of the product comprises comparing the first characteristic to a database of product information.

In any of the various embodiments discussed herein, the method further includes detecting an identifier on the product by an identifier sensor, wherein the determining the identity of the product comprises comparing the identifier to the database of product information.

In any of the various embodiments discussed herein, the method further includes using machine learning to assign a confidence level to the determining the identity of the product.

Some embodiments are directed to a vending system that includes a cabinet, a camera, and a control unit. In some embodiments, the cabinet includes a storage area for storing products and a door coupled to the cabinet that is movable between a closed configuration and an open configuration in which the products are accessible to a consumer. In some embodiments, the camera is arranged within the cabinet and configured to detect characteristics of a product. In some embodiments, the characteristics include a first characteristic and a second characteristic, the first characteristic includes a visual characteristic of the product, and the second characteristic comprises infrared energy. In some embodiments, the control unit is in communication with the camera, configured to determine an identity of the product based on the first characteristic, and configured to determine a temperature of the product based on the second characteristic.

In any of the various embodiments discussed herein, the visual characteristic includes a shape of the product, a dimension of the product, or a coloring of the product.

In any of the various embodiments discussed herein, the camera is configured to detect the first and second characteristics of the product during a first time period to determine the identity of the product and the temperature of the product, wherein the first time period corresponds to the product being removed from the cabinet.

In any of the various embodiments discussed herein, the camera is configured to detect the first and second characteristics during a second time period to determine the identity of the product and the temperature of the product, and the second time period corresponds to the product being returned to the cabinet.

In any of the various embodiments discussed herein, the control unit is configured to determine a price of the product based on the identity of the product and the temperature of product during the first time period.

In any of the various embodiments discussed herein, the control unit is configured to compare the detected visual characteristics at the first time period to the detected visual characteristics at the second time period.

In any of the various embodiments discussed herein, the camera is configured to detect infrared energy at the first time period and at the second time period, and the control unit is configured to determine the temperature of the product at the first time period and at the second time period.

In any of the various embodiments discussed herein, the control unit is configured to determine, based at least in part on a comparison of the temperature at the first time period and the temperature at the second time period, whether the product being returned matches the product being removed.

In any of the various embodiments discussed herein, the control unit is configured to determine the identity of the product based at least in part on a comparison of the visual characteristic to a database of product information.

In any of the various embodiments discussed herein, the vending system includes an identifier sensor configured to detect an identifier of the product, and the control unit is configured to determine the identity of the product based at least in part on a comparison of the identifier to a database of product information.

In any of the various embodiments discussed herein, the vending system includes a plurality of cameras, and each camera of the plurality of cameras is configured to detect the visual characteristics, and each camera of the plurality of cameras is configured to detect the infrared energy.

In any of the various embodiments discussed herein, the camera is configured to detect the infrared energy when the door is in the closed configuration.

In any of the various embodiments discussed herein, the camera is an RGB-IR camera.

In any of the various embodiments discussed herein, the vending system includes a lock configured to lock the door in the closed configuration, and the control unit is configured to lock the lock in response to a determination that a temperature of the product is greater than 5° C.

### BRIEF DESCRIPTION OF THE FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 shows a vending system according to some embodiments.

FIG. 2 shows a schematic diagram of components of a system for identifying a product stored in, removed from, and/or returned to a cabinet of a vending system according to some embodiments.

FIG. 3 shows a top-down view of a shelf of a vending machine showing an arrangement of cameras according to some embodiments.

FIG. 4 shows a top-down view of a shelf of a vending machine showing the location of cameras according to an embodiment.

FIG. 5 shows a perspective view of a vending system having cameras according to some embodiments.

FIG. 6 shows a method for identifying a product and determining a temperature of a product according to some embodiments.

FIG. 7 shows a method of identifying and monitoring products stored in, removed from, and/or returned to a cabinet of a vending system according to some embodiments.

FIG. 8 shows a schematic block diagram of an exemplary computer system in which some embodiments may be implemented.

### DETAILED DESCRIPTION

Vending systems generally require a consumer to enter a payment, make a product selection, and wait for the product to be dispensed by the vending system. However, the consumer can encounter multiple problems when using a vending system. First, the vending system may not accept the consumer's form of payment. For example, the vending system may not accept paper bills that are creased or wrinkled. The vending system may not properly register receipt of bills or coins, and thus the consumer may not receive credit for entered payment. The vending system may not be configured to accept mobile payment which can be inconvenient for the consumer. Further, the vending system may fail to read a payment card, such as a credit card or debit card. As a result, the consumer may be unable to make a purchase, or the consumer may become frustrated and decide to not use the vending system.

Second, once payment is entered, the consumer may incorrectly enter the code corresponding to the desired product. As a result, a different product may be dispensed than the consumer anticipated. The consumer is unable to return the incorrect product, and the consumer may have no recourse. Further, vending systems generally allow a consumer to purchase only a single product at a time, requiring the consumer to repeat the process of entering payment and selecting a product in order to purchase multiple products. Repeating the same steps can be time consuming and frustrating, and may deter the consumer from making multiple purchases.

Third, the vending system may fail to properly convey the product to the user. For example, a screw drive may fail to move the product to the dispensing opening of the vending system, or a gate holding the product in place may not fully open. Additionally, the product may become stuck or lodged within the vending system and may not be accessible by the consumer. As a result, the consumer may not receive the product and cannot obtain a refund of their payment.

Vending systems have various additional drawbacks such as the inability for the consumer to personally select a specific product. Instead, the consumer simply selects the type of product, but cannot pick the exact product to be dispensed. Further, the consumer cannot handle or inspect the product before purchasing. As a result, the consumer may not be able to learn about the product, such as to read the label, ingredients, or nutritional information. This may discourage the consumer from purchasing products that are not familiar. The dispensed product may be damaged, expired, or otherwise deficient. These various factors can contribute to a poor user experience.

Although some systems allow a user to remove and handle a product, these systems may not allow a user to return the product to the vending system, or may not alert a user when there is an issue with the product, such as when the purchased product temperature is outside of an optimal range.

Additionally, although some systems allow a user to return a product to the vending system, those systems cannot easily detect unauthorized activity (e.g., if a user is returning the same product that was removed). Such unauthorized activity can occur in vending systems that can be used to store and sell chilled products (e.g., food and beverage). Often these products are also offered at retailers both chilled (e.g., in vending systems or refrigerators) and at ambient temperature. The chilled products typically sell for at least 5×-10× the price per unit compared to the ambient temperature products.

Existing vending systems that allow a user to remove a product and return the product cannot determine if the product being returned is the same product and at the same temperature. This means a consumer could remove a chilled product, replace it with an ambient product, and then purchase the chilled product at a point of sale system, which will charge the consumer for the ambient product. This can reduce the revenue generated by the vending system.

Moreover, it can create a frustrating experience for a later consumer who may attempt to purchase a product that is not chilled to an optimal temperature. For example, if a prior consumer swaps a chilled product for an ambient product, a later consumer may purchase that ambient product, which may not have fully chilled yet. This can create a frustrating experience for the later consumer and can potentially harm the consumer's perception of the product they have purchased.

Thus, improved vending systems are desired that provide a simple and easy purchasing experience while also charging the consumer for the actual product they retrieve from the vending system. Further, vending systems are desired that allow a consumer to personally select one or more products and that ensure dispensing of the desired product.

Embodiments disclosed herein include vending systems that provide consumers with access to the compartment in which the products are stored. In this way, the consumer can inspect the products to review the label, nutritional information and the like when deciding whether to purchase the product. Further, the consumer can select the exact product desired to be purchased. The consumer may readily purchase multiple products in a single transaction.

Such vending systems may accept a payment source from a consumer or identify the consumer, provide the consumer with access to the cabinet in which the products are stored, detect the products removed from the cabinet by the consumer, and charge the consumer for the selected products. While such vending systems may provide added convenience to the consumer, accurately detecting products selected by the consumer presents numerous technical challenges. If products removed from the cabinet are not identified and charged to the consumer, the owner of the vending system may lose income. Additionally, if products removed are not correctly identified, the consumer may be charged the wrong price, and the inventory of the vending system may be incorrectly maintained. Considerations must also be made to ensure that consumers do not tamper with products or otherwise engage in unauthorized activities.

In order to ensure accurate identification of products removed and/or returned to the vending system, the vending system must be able to differentiate between a variety of products, many of which may be similar in appearance. For example, many beverage bottles may be the same size and shape, particularly beverages from the same manufacturer. Thus, some products may differ only by small details on the packaging, such as the product name or coloring.

Additionally, the system must be able to differentiate between two products that are the same in all aspects except temperature. This can address the issue when a consumer replaces a chilled product with a product at ambient temperatures and then purchases the chilled product for the price of a product at ambient temperatures.

In order to ensure proper use of the vending system, precautions must be taken to prevent unauthorized conduct, such as stealing or tampering with products, or damaging the vending system. A consumer may try to remove a chilled product from the vending system and replace it with an ambient product without detection so that the product will not be charged to the consumer, and the consumer can purchase the ambient product at a point of sale. Alternatively, a consumer may try to deceive the vending system by inserting external objects into the vending system in place of products to make it appear that a product has been returned. If consumers are able to steal or tamper with products, the owner of the vending system may suffer loss of income. Other consumers may not choose to use the vending system 100 if the products available for purchase are damaged.

The vending system must also be able to detect the product in various orientations. The products may be arranged in the cabinet with various orientations, and consumers may remove products from the vending system in different manners. Consumers may select products in ways that obscure the product, inhibiting identification. For example, a consumer may grab multiple products in one hand, making it difficult to detect each individual product selected. Consumers may also remove a product and return the product to a different location and in a different orientation than the product was initially positioned.

Some embodiments described herein relate to systems and methods for both identifying products stored in a cabinet, removed from the cabinet, and/or returned to the cabinet. Such systems and methods can also determine the temperature the products stored in a cabinet, removed from the cabinet, and/or returned to the cabinet. Such systems and method can use a static or dynamic camera that can be used to both identify the product and also determine the temperature of the product. Accordingly, such systems and methods can determine identity of the product and the temperature of the product without a separate temperature sensor. Such systems and methods can also include an identifier sensor in which data collected by the camera and identifier sensor are compared to a database of product information.

In this way, a product can be accurately identified without the consumer having to manually scan or enter information about a product, simplifying purchase of products from the vending system. Some embodiments described herein relate to systems and methods for identifying a product removed from a cabinet that includes generating a digital map of products within the cabinet. The digital map provides a baseline of the location and identity of products within the cabinet and may be used to confirm identification of a product removed from the cabinet by cameras or sensors in the cabinet.

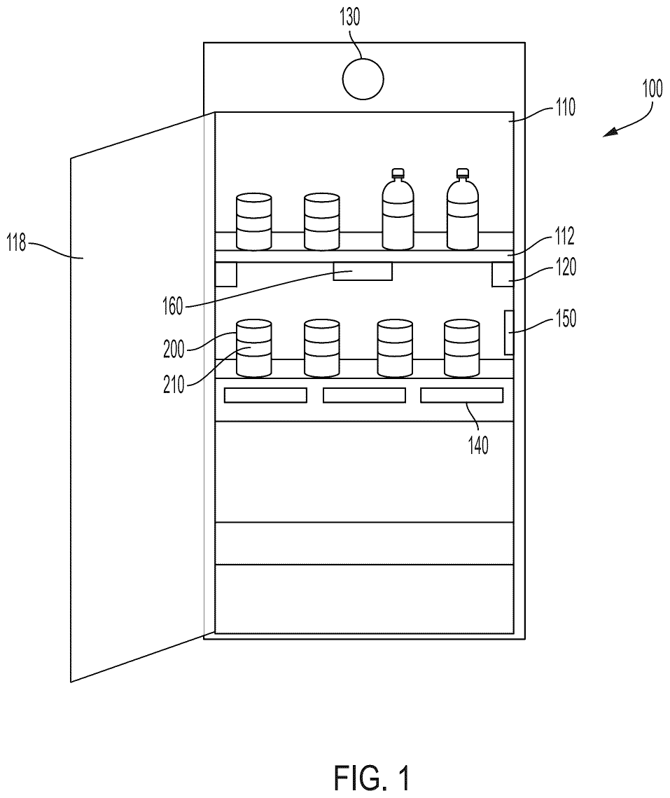

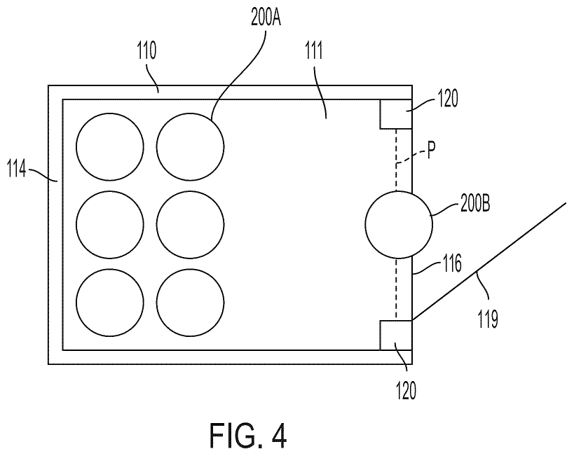

In some embodiments, a vending system 100 may include a cabinet 110 having a plurality of products 200 stored within cabinet 110, as shown in FIG. 1. Cabinet 110 may further include a door 118 that can be opened to provide access to the plurality of products 200 within cabinet 110. In some embodiments, door 118 can be locked and unlocked to control access to an interior of cabinet 110. Cabinet 110 can include multiple compartments 111 disposed within cabinet 110. In some embodiments, each compartment 111 can store products 200. In some embodiments, each compartment 111 includes a door 119, as shown in FIG. 4, that can be locked and unlocked to control access to compartment 111. Each door 119 can be locked independent of other doors 119 such that access to each compartment 111 can be independently controlled. This allows for perishable products to be stored separately from shelf stable products. For example, a door 119 of a compartment 111 containing perishable products can be automatically locked if the temperature of the perishable products exceeds a predetermined temperature (e.g., 7° C. or 5° C.). And the door 119 can remain locked until an operator unlocks door 119 and/or until the perishable items are removed. As another example, a door 119 of compartment 111 containing shelf-stable products can be automatically locked if the temperature of the shelf-stable products exceeds a predetermined temperature (e.g., 7° C. or 5° C.). And the door 119 can be automatically unlocked when the temperature of the shelf-stable products returns to less than the predetermined temperature. In some embodiments, compartments 111 can be modular and removable from cabinet 110. In some embodiments, compartments 111 can be modular like modular storage units 400 described in U.S. patent application Ser. No. 17/930,613, the entire contents of which are incorporated herein by reference. For example, in embodiments in which each compartment 111 is independently lockable, each compartment 111 may have the structure modular storage unit 400 of the '613 application.

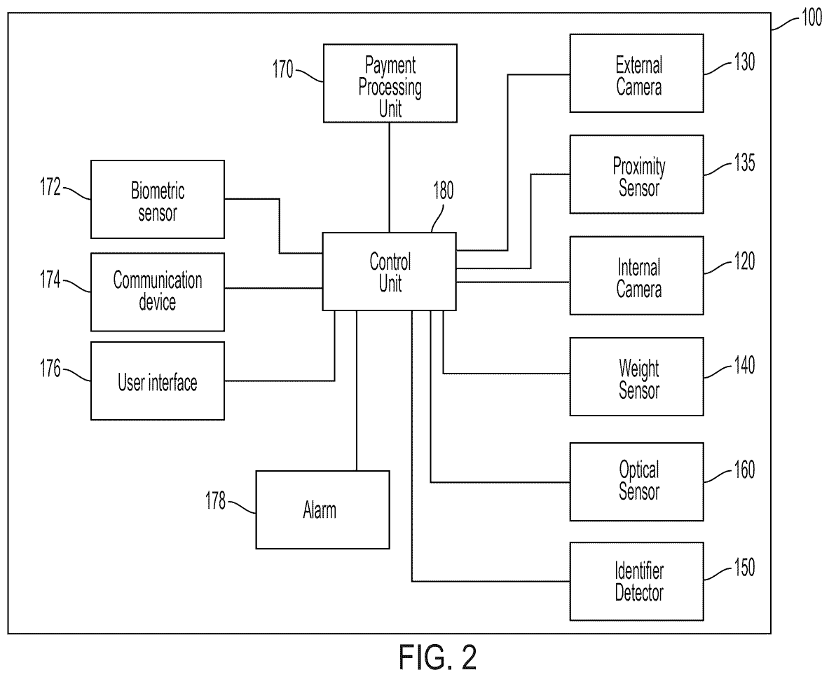

Cabinet 110 may include one or more cameras 120, 130 or sensors 140, 150, 160 for identifying products. In some embodiments, at least one of cameras 120 or 130 is an RGB-IR camera. In some embodiments, at least one of cameras 120 or 130 is an FLIR camera. Specifically, cameras and/or sensors are configured to identify products stored in, removed from, and/or returned to cabinet 110 so that the consumer is charged for the appropriate products removed from cabinet 110. Data collected by the sensors and cameras is analyzed, such as by a control unit 180 (see FIG. 2), to determine the identity of the product removed. The analysis may include a comparison of the data from the cameras and sensors to a database of product information and/or a product inventory.

The detection system and methods described herein may be used in a vending system that allows a user to manually select and remove products from a cabinet in which the products are stored. A vending system that allows a consumer to manually select and remove products is described for example in U.S. patent application Ser. No. 16/864,676, filed Mar. 1, 2020, which is incorporated herein by reference in its entirety. An exemplary vending system 100 incorporating a product identification system and method is described herein for illustrative purposes only. One of ordinary skill in the art will appreciate that the product identification system and methods described herein can be used with other types of vending systems or merchandisers, and can be utilized in other environments for product identification.

A vending system 100 may have components as shown for example in FIG. 2. However, vending system 100 need not have each and every component shown in FIG. 2, and may include additional components. Vending system 100 can include various types of vending systems, including coolers, vending machines, refrigerators, and beverage dispensers.

Vending system 100 may be configured to authenticate a consumer's identity. Vending system 100 may include an external camera 130 to identify a consumer by facial recognition, or a biometric sensor 172 to obtain biometric information from the consumer, such as a thumbprint or iris. In some embodiments, vending system 100 may alternatively or additionally include a communication device 174, such as a wireless transceiver, for communicating with a mobile device, such as a cell phone, so that the consumer may authenticate or provide payment via a mobile device. In such embodiments, the mobile device may have a software application to facilitate interaction with vending system 100. The consumer's identity may be linked with a consumer profile that includes information about the consumer, such as a payment source, so that the consumer need not manually enter a payment when using vending system 100, and the consumer's purchase can be automatically credited to the consumer's profile.

Vending system 100 may not require authentication of a consumer and may simply accept a form of payment from the consumer. Vending system 100 may include a payment processing unit 170 that may include one or more slots to receive paper money, coins, or tokens. Payment processing unit 170 may include a card reader to read a magnetic stripe or an electronic chip of a credit card, debit card, gift card, or the like, or that includes a near field communication (NFC) antenna to receive contactless payment from a contactless payment card. Payment processing unit 170 may include a communication device to accept mobile payments or cryptocurrency from a mobile electronic device, such as a cell phone, watch, laptop, tablet, or the like, or payment processing unit 170 may include a scanner to scan a payment code, such as a quick response (QR) code.

Upon authenticating a consumer's identity or receiving a payment from the consumer, door 118 of vending system 100 may be automatically unlocked so that the consumer may access the plurality of products 200. The products removed by the consumer may be identified by methods as described herein. A virtual shopping cart displayed on a user interface 176 or on the user's mobile device may list the products removed from cabinet 110 along with the price of the products, and a total price of the products.

Purchase of the removed products may be completed when the consumer closes door 118 of vending system 100. To complete the purchase, the consumer may provide an input, such as making a selection to complete the transaction on a user interface 176 of vending system 100, or performing a gesture on a user interface 176 having a touch screen, such as swiping along a path. Alternatively, the purchase may be completed automatically when door 118 is closed for a predetermined period of time.

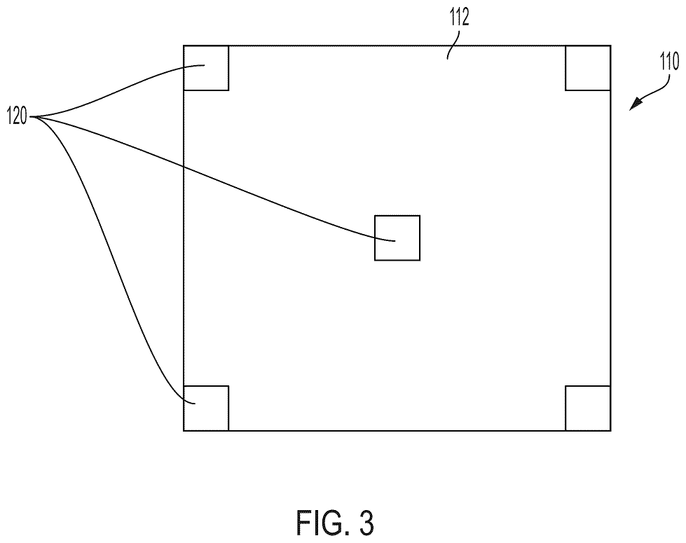

In some embodiments, vending system 100 may include one or more internal cameras 120 within cabinet 110 for identifying products, as shown in FIG. 3. Cameras 120 may be configured to capture static images, videos, or both. Additionally, cameras 120 may be configured to detect infrared energy. In some embodiments, cameras 120 are configured to both detect infrared energy and capture static images and/or videos. In some embodiments, a plurality of cameras 120 may be arranged to capture images or videos of products on each shelf 112 of cabinet 110. A camera 120 may be arranged at one or more corners of cabinet 110 above each shelf 112. Further, in some embodiments, a camera 120 may be arranged centrally above each shelf 112 so as to capture an image of a central portion of shelf 112. For example, a camera 120 may be arranged in each of four corners of cabinet 110 and a fifth camera may be arranged above a central portion of shelf 112. In this way, the cameras 120 may capture products from different angles and can detect products that may be obscured in a view from a particular camera 120. Further, cameras 120 can view any products within cabinet 110, and may have overlapping fields of view. For example, a camera 120 arranged at a front portion 116 of cabinet 110 may not fully capture a product arranged at a back portion 114 of cabinet 110. A best image from cameras 120 may be selected for analysis to determine the identity of the product, or a composite image incorporating various images may be generated and analyzed.

In some embodiments, one or more cameras 120 may be configured to capture images or video of a product stored in, exiting, or entering cabinet 110, as shown in FIG. 4. Cameras 120 may be arranged at front portion 116 of cabinet 110. In some embodiments, cameras 120 may be positioned at corners of front portion 116 of cabinet 110 or may be positioned about a perimeter of front portion 116 of cabinet 110. Cameras 120 may define a plane P that is parallel to a front portion 116 of cabinet 110. In this way, a product 200B exiting or entering the cabinet 110 must pass through plane P and is thus detected by cameras 120. Cameras 120 may capture an image or video to identify product 200B and determine the temperature of product 200B when removed from cabinet 110 and/or when returned to cabinet 110. Cameras 120 at front portion 116 of cabinet 110 may have a clear view of a product 200 as it is being removed by the consumer as the product 200 is not obscured by other products within the cabinet.

Cameras 120 may be used to detect a visual characteristic of a product. The visual characteristic may include a shape of the product, a dimension of the product, a coloring of the product, or a combination thereof. Cameras may also be used to determine a location of a product within cabinet 110.

The shape of the product may be a silhouette or 2-D view of the product, such as a front profile, a side profile, a rear profile, a top-down view, or a bottom-up view. For example, if the product is a can, the shape may be a circular shape when viewed in a top-down manner, or a generally rectangular shape when viewed in a side profile. In some embodiments, shape may be a 3-D view, such as a perspective view of the product. The 3-D view may be generated by combining the 2-D views from various cameras. In some embodiments, cameras may be used to generate a model of each product. The model may be a 2-D model that includes a shape and color or color palette. In some embodiments, the model may be a 3-D model that includes the product's shape, dimensions, and a color or color palette. Cameras 120 may have depth sensors to aid in generation of the 3-D model. The cameras may determine the dimensions of the product so that products with similar shapes may be distinguished. For example, a 12 oz. can and a 16 oz. can are distinguishable despite both being cylindrical. In some embodiments, in order to ensure accuracy, cameras may be configured to determine the dimensions of products within ±5 mm, ±3 mm, or ±1 mm.

The visual characteristic may include a coloring of the product. The coloring may be a color of any portion of the product, or a pattern or combination of colors, e.g., a color palette. For example, the visual characteristic may be the color of the packaging, the color of text, logos or markings on the packaging, among other colored items. For example, when the product is a bottled beverage, the coloring may be a color of the bottle (e.g., clear, green), a color of the liquid within the bottle, a color of the bottle cap, a color of the label, or a color of the writing or markings on the label, and combinations thereof.

In some embodiments, an identifier sensor 150 (see, e.g., FIG. 1) may detect an identifier 210 of a product 200. An identifier 210 of a product may include a label, barcode, QR code, text (such as a brand, product, or flavor name), logo, or other markings on the product. In some embodiments, the identifier sensor may be a camera 120. In some embodiments, identifier sensor 150 may be a separate component, such as a scanner for scanning a barcode or QR code. Identifier sensor 150 may have sufficiently high resolution so that text on a product 200 can be read. In some embodiments, a control unit 180 of vending system 100 may perform optical character recognition (OCR) to identify text in a captured image of a product. Captured images or video may have sufficient pixel density to allow for accurate identification of the text. In some embodiments, a minimum pixel density for identifying text may be about 2 pixels/mm. Further, identifier sensor 150 may have a high frame rate to provide sharp images to facilitate OCR.

In some embodiments, a convolutional neural network (CNN) may be used to detect an identifier 210 on a product 200 as will be appreciated by one skilled in the art, such that the identifier 210 may be analyzed for product recognition. CNN may be trained based on products available in vending system 100 to increase accuracy. Further, identifier sensor 150 may have sufficient resolution to resolve differences in identifiers 210 of related products (e.g., Pepsi, diet Pepsi, cherry Pepsi). In some embodiments, for example, accurate identification of products may require a minimum pixel density of 1.5 pixels/mm.

Identifier sensor 150 may assist in determination of the specific stock keeping unit (SKU). For example, one or more cameras 120 may detect a size and shape of a product, but multiple products in cabinet 110 may be the same size and shape. Thus, identifier sensor 150 may help to determine the specific type of product by detecting an identifier 210 of the product. Alternatively, if the cameras 120 alone are able to determine an identity of the removed product, the information provided by identifier sensor 150 may be used to increase confidence that the product has been correctly identified or to confirm that identification of the product based on the cameras 120 is correct.

A control unit 180 may be configured to receive and analyze data from the cameras 120 and identifier sensor 150 to determine a product identity and to determine a product temperature. Control unit 180 may also store a database of product information. The database may include information about the products stored in cabinet 110. The database may include for example a list of products. For each product, the database may include corresponding visual characteristics, such as a shape or silhouette, dimensions, and coloring of the packaging, product weight, and further information about a product label and identifiers. To identify a product removed from the cabinet, the analysis may determine a product in the database that has visual characteristics that correspond to, or best match, the visual characteristics determined based on data from cameras 120 and sensor 150. In some embodiments, control unit 180 may execute sensor fusion algorithms for determining product identity based on data from cameras 120 and sensors 150. Artificial intelligence and machine learning may be used to analyze the data from cameras 120 and sensors in combination with the database of product information to determine a product identity. In some embodiments, artificial intelligence and machine learning may assign a confidence level to the product identification. Computer vision technology may be used to analyze data, such as images or video from cameras and sensors as will be understood by one of ordinary skill in the art. In some embodiments, artificial intelligence or computer vision technology may be employed remotely from vending system 100. For example, cloud computing, edge computing, or a combination thereof may be used to analyze data from cameras 120 and sensors.

In some embodiments, control unit 180 may also store a product inventory of vending system 100 so that it is known what products are in cabinet 110. Thus, the identification of products removed is limited to products known to be in cabinet 110, or on a particular shelf 112 from which the product 200 was removed.

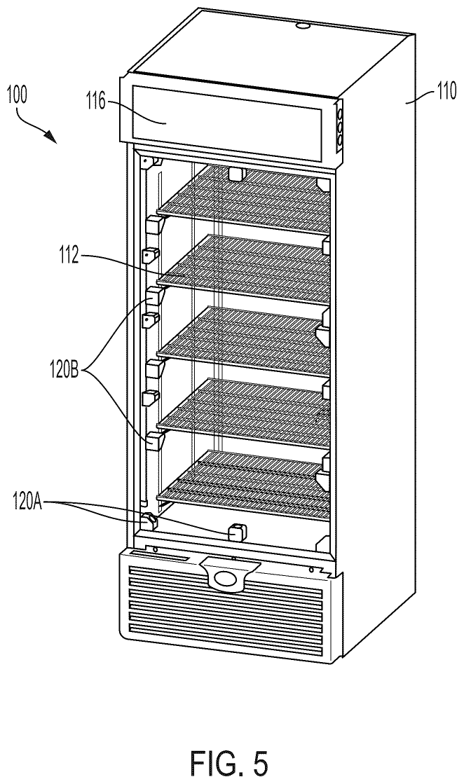

In some embodiments, a vending system 100 may include internal cameras 120, as shown in FIG. 5. Vending system 100 includes a cabinet 110 having shelves 112 on which products may be stored. A first plurality of cameras 120B may be positioned above each shelf 112 so as to detect products on each shelf 112 inside of the cabinet 110. First plurality of cameras 120B may include cameras 120B at corners of each shelf 112 and at a central portion of each shelf 112. A second plurality of cameras 120A may be arranged at front portion 116 of cabinet 110. Second plurality of cameras 120A may be configured to detect a product removed from or returned to cabinet 110, as described above with respect to FIG. 4. The second plurality of cameras 120A may be positioned about a perimeter of front portion 116. However, in some embodiments, fewer or additional cameras 120 may be included.

In some embodiments, a method 1000 of monitoring products 200 in cabinet 110 can include using cameras 120 to determine the identity of one or more products 200 stored in cabinet 110. In some embodiments, method 1000 includes determining an identity of a product removed from cabinet 110 using a camera to capture a video of products entering or exiting cabinet 110.

In some embodiments, at step 1002, the system can detect one or more characteristics of products 200 stored in cabinet 110. This can be done, for example, using camera 120 to take photos and/or video of the product 200 to capture visual characteristics of the product 200. In some embodiments, one or more cameras 120 can detect a first characteristic that includes one or more visual characteristics. In some embodiments, as discussed above, the visual characteristics can include one or more of a shape or silhouette, dimensions, and coloring of the packaging. In some embodiments, one or more identifier detectors 150 can detect a first characteristic that includes one or more identifiers of products 200. In some embodiments, at step 1002, the system detects only visual characteristics of product 200. In some embodiments, at step 1002, the system detects only identifiers of product 200. In some embodiments, at step 1002, the system detects both visual characteristics and identifiers of product 200. In some embodiments, at step 1002, the system detects visual characteristics and/or identifiers of only one product 200. In some embodiments, at step 1002, the system detects visual characteristics and/or identifiers of more than one product 200.

In some embodiments, at step 1004, one or more cameras 120 can detect a second characteristic of product 200. The second characteristic can include infrared energy. In some embodiments, at step 1002, the system detects infrared energy of only one product 200. In some embodiments, at step 1002, the system detects infrared energy of more than one product 200. In some embodiments, the same camera 120 that detects the first characteristic at step 1002 detects the second characteristic at step 1004.

In some embodiments, at step 1006, the system can determine, based on the detected visual characteristics, an identity of product 200. The control unit 180 can determine, based on the detected visual characteristics, the identity of product 200. The visual characteristic can be any visual characteristic discussed above. In some embodiments, control unit 180 can compare the detected visual characteristics to a database of product information and/or product inventory, as described above. For example, the visual characteristic and/or identifier may be analyzed to determine a product identity, which may be based on a database of product information. In some embodiments, the visual characteristic and/or identifier may be analyzed for correspondence with a product inventory or digital map of products in the cabinet. The identity of the product may be determined based on the analysis of the visual characteristic and identifier and the database of product information. In some embodiments, the visual characteristic or identifier alone may be used to identify the product, and the other of the visual characteristic or identifier may be used to confirm the identity of the product.

In some embodiments, at step 1008, the system can determine, based on the detected infrared energy, the temperature of products 200. The control unit 180 can determine, based on the detected infrared energy the temperature of products 200. In some embodiments, the control unit 180 can determine the temperature of products 200 based only on the infrared energy. In some embodiments, vending system 100 does not include a temperature sensor for determining the temperature of products 200.

In some embodiments, method 1000 can be used for inventory tracking. For example, method 1000 can be used to monitor the number of products 200 stored in cabinet 110. In some embodiments, control unit 180 can track the number of different products 200 in cabinet 110 as consumers remove products and return products to cabinet 110. In some embodiments, when one or more types of products are low on inventory, control unit 180 can be configured to notify a third party (e.g., a retailer, supplier, and/or operator) that the inventory is low.

In some embodiments, method 1000 can be used for quality control. For example, when the temperature of product 200, as determined at step 1008, is greater than a predetermined value, control unit 180 can be configured to lock door 118 of cabinet 110. In some embodiments, control unit 180 can be configured to unlock door 118 of cabinet 110 when the temperature of product 200, as determined at step 1008, is less than a predetermined value. Control unit 180 can be configured to automatically lock or unlock door 118 based on the determined temperatures. In some embodiments, door 118 locks only when the product 200 is a non-preserved and/or perishable product (e.g., juices and milk) and when the temperature exceeds the predetermined value. In some embodiments, the predetermined value is about 7° C. or about 5° C.

In some embodiments, control unit 180 can be configured to lock each door 119 independently of other doors 119 and independently of door 118. In some embodiments, control unit 180 can be configured to unlock each door 119 when the temperature of product 200 in the respective compartment 111, as determined at step 1008, is less than a predetermined value. Control unit 180 can be configured to automatically lock or unlock doors 119 based on the determined temperatures. In some embodiments, doors 119 lock only when the product 200 is a non-preserved and/or perishable product (e.g., juices and milk) and when the temperature exceeds the predetermined value. In some embodiments, the predetermined value is about 7° C. or about 5° C.

In some embodiments, the control unit 180 is configured to change the predetermined value based on various parameters, such as weather, time of day, expected sales, time since restocking, etc. For example, in some embodiments the predetermined temperature is larger during periods of large expected sales to accommodate the added heat from more frequent opening and closing of door 118. Further, the predetermined value can be increased for a period of time after restocking to accommodate for the time it takes for new, unchilled products to come to optimal temperature after being restocked. In some embodiments, the predetermined value is increased for a first time period and then automatically returned to the original predetermined value.

The predetermined temperature can be based on the location of the vending system 100. For example, in the United States, vending system 100 can use a predetermined temperature for products 200 of about 7° C. In other countries or regions, where consumers may be accustomed to warmer beverages, the vending system 100 can use a predetermined temperature of about 13° C. The predetermined temperature can also vary from one vending system 100 to another, based on the optimal temperature for that specific machine. The optimal temperature can be determined, for example, based on a machine learning system that collects and analyzes data related to usage of a specific vending system 100 or a network of vending systems 100.

In some embodiments, control unit 180 is configured to lock door 118 in response to determining that the temperature of at least 10% of the products is greater than the predetermined value. In some embodiments, control unit 180 is configured to lock door 118 in response to determining that the temperature of at least 10% of the products is greater than the predetermined value for a predetermined time. In some embodiments, the predetermined time is from about 10 minutes to about 180 minutes (e.g., from about 45 minutes to about 150 minutes, from about 60 minutes to about 120 minutes). In some embodiments, the predetermined time is about 120 minutes. In some embodiments, control unit 180 is configured to unlock door 118 in response to determining that the temperature of at least 90% of the products is less than 7° C. or less than 5° C.

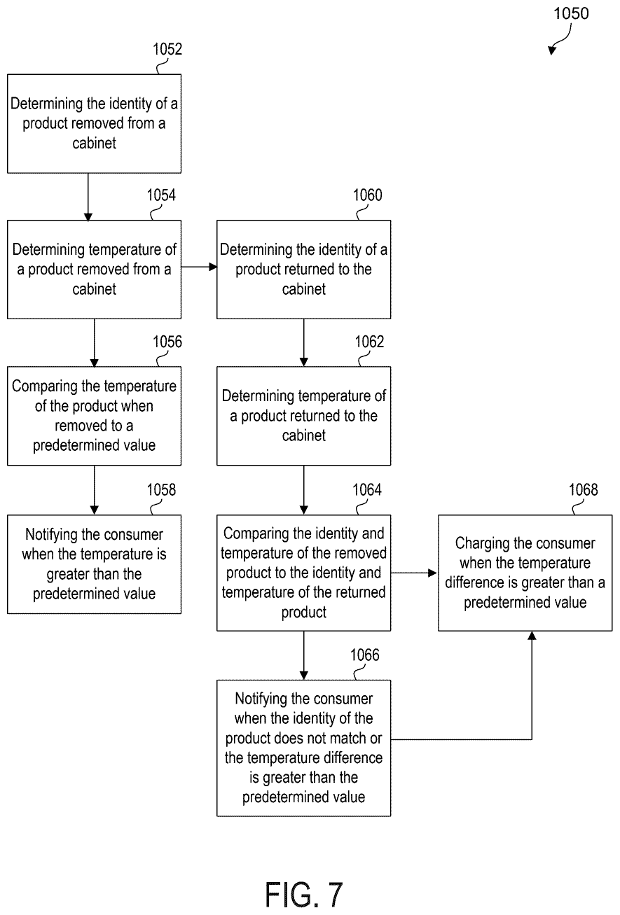

In some embodiments, a method 1050 of monitoring products 200 removed from and returned to cabinet 110 can include the steps illustrated in FIG. 7. In some embodiments, at step 1052, the system can determine the identity of product 200 when it is removed from cabinet 110, for example, by a consumer. In some embodiments, at step 1052, the identity of the removed product is determined as discussed above related to method 1000 (e.g., steps 1002 and 1006). In some embodiments, at step 1054, the temperature of the removed product is determined as discussed above related to method 1000 (e.g., steps 1004 and 1008). In some embodiments, at step 1056, the temperature of the removed product is compared to a predetermined value. In some embodiments, the predetermined value is about 7° C. or less than about 5° C. In some embodiments, the predetermined value is about 7° C. In some embodiments, at step 1058, the control unit 180 is configured to notify the consumer when the temperature of the removed product, as determined at step 1054, exceeds the predetermined value. In some embodiments, at step 1058, the user is notified via user interface 176. In some embodiments, user interface includes a display.

A user will sometimes return a product to cabinet 110 after it has been removed. In that case, method 1050 includes steps 1060 through 1066. In some embodiments, at step 1060, the system can determine the identity of product 200 when it is returned to cabinet 110, for example, by a consumer. In some embodiments, at step 1060, the identity of the returned product is determined as discussed above related to method 1000 (e.g., steps 1002 and 1006). In some embodiments, at step 1062, the temperature of the removed product is determined as discussed above related to method 1000 (e.g., steps 1004 and 1008). In some embodiments, at step 1064, the identity and temperature of the returned product determined at steps 1060 and 1062 to the identity and temperature of the removed product determined at steps 1052 and 1054. In some embodiments, at step 1066, the control unit 180 is configured to notify the consumer when the identity of the returned product does not match the removed product. In some embodiments, at step 1066, the control unit 180 is configured to notify the consumer when the temperature difference between the returned product and the removed product is greater than a predetermined value. In some embodiments, the predetermined value is from about 10° C. to about 20° C., from about 12° C. to about 18° C., from about 13° C. to about 15° C., or within a range having any two of these values as endpoints. In some embodiments, the predetermined value is about 13° C. In some embodiments, the predetermined value is about 15° C. In some embodiments, the predetermined value is at least 13° C. In some embodiments, control unit 180 can display a notification on user interface 176. In some embodiments, in response to determining that the consumer has returned a product that does not correspond to the product removed, control unit 180 can automatically prompt the user to return the appropriate product 200. In some embodiments, the system can automatically charge the consumer for the product removed when the product returned does not match the product removed. This can be done, for example, using payment processing unit 170.

In some embodiments, in any of the various systems and methods described herein, cameras 120 and/or identifier detectors 150 may be activated when door 118 of cabinet 110 is opened and may deactivate when door 118 is closed so that images and/or video are captured only when the cabinet 110 is being accessed by a consumer. In some embodiments, the cameras 120 and/or identifier detectors 150 can be operated continuously to continuously monitor the inventory in cabinet 110 and/or the temperature of products 200 in cabinet 110. In some embodiments, in any of the various systems and method described herein, camera 120 can capture images and/or video of a product 200 at multiple times, for example, before door 118 is opened, when door 118 is opened, while product 200 is being removed from cabinet 110, while product 200 is being returned to cabinet 110. For example, to confirm that a product removed from cabinet 110 matched a product returned to cabinet 110, camera 120 can capture images and/or video of product 200 while product 200 is removed from cabinet 110 and while product 200 is returned to cabinet 110.

In some embodiments, in any of the various systems and method described herein, the cameras may capture images at a set interval or cameras may capture an image when the door 118 of the cabinet 110 is closed. When multiple cameras are used, the images from the multiple cameras may be combined into a composite image, or the best image may be used.

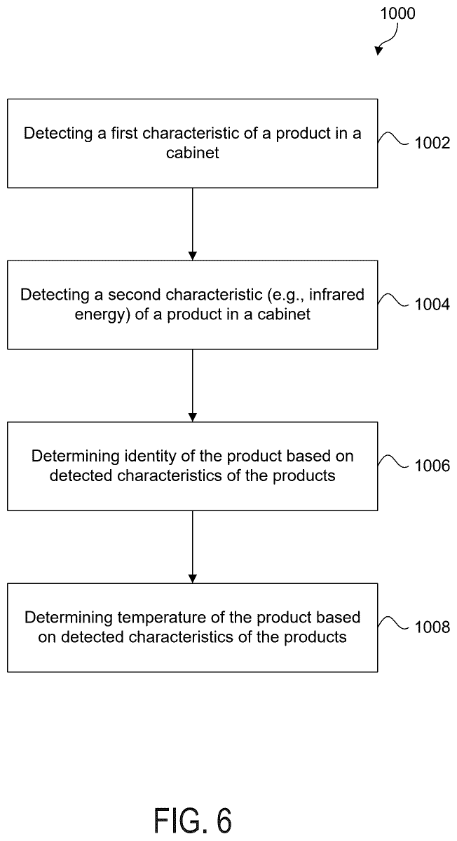

In some embodiments, a combination of images and videos captured by cameras may be used to identify a product, for example, by method 1000 shown in FIG. 6. In such embodiments, a camera may capture an image of products within the cabinet. Another camera may capture a video of product 200 being removed from cabinet 110 and/or product 200 being returned to cabinet 110. A second image may be captured of the products in the cabinet 110 after the product 200 has been removed and/or returned to cabinet 110. The video may be analyzed to determine a visual characteristic of the product, and artificial intelligence may use the visual characteristic and a database of product information to determine the identity of the product. The identity of the product as determined based on the captured video may be confirmed by an analysis of the first and second images to determine a location or visual characteristic of the removed product. Alternatively, the product identification may be made by analyzing the first and second images, and the data from the video may be used to confirm the identification.

In some embodiments, the system can determine whether products are at appropriate temperatures and determine a removed product is properly returned, for example, by method 1050 shown in FIG. 7. In some embodiments, as described above related to method 1050, the determination of whether a product is properly returned can be aided by cameras 120. For example, cameras 120 may detect a visual characteristic of the product removed and of the product returned to determine if the visual characteristic is the same. Further, cameras 120 may detect infrared energy of the product removed from and returned to the cabinet 110 to determine if the temperature of the returned product is close to the temperature of the removed product. If the visual characteristic or the temperature of the product returned differs from the visual characteristic or the temperature of the product removed, the consumer may have tampered with the product or attempted to return a different item.

In some embodiments, an optical sensor 160 may be used in addition to cameras 120 to determine a visual characteristic and/or a location of a product (see, e.g., FIG. 1). Optical sensor 160 may be arranged within cabinet 110 and may view substantially an entire of interior of cabinet. Optical sensor 160 may use different optical wavelengths. In some embodiments, optical sensor 160 may be used to aid in determination of the location, size, and shape of each object in cabinet 110. Data from optical sensors may determine the size, shape and location of products that may be obscured from the view of cameras. Further, if a consumer removes and returns a product to a different location, optical sensor can determine the location of the product.

In some embodiments, optical sensor may be an RFID sensor. In such embodiments, cabinet 110 may include an RFID sensor configured to detect the presence of RFID tagged products. Thus, when a product is removed from cabinet, RFID sensor may determine the identity of the product removed. In some embodiments, optical sensor may be a light detection and ranging (LIDAR) sensor or a magnetic resonance imaging (MRI) sensor, among others. Data from optical sensor 160 may be used to confirm the identity of the product removed from the cabinet 110 as determined by other sensors or cameras. This may help to increase the accuracy of the product identification.

In some embodiments, vending system 100 may include an external camera 130, as shown in FIG. 1. External camera 130 may be configured to view an area external to vending system 100. External camera 130 may be positioned outside of cabinet 110, or may be arranged within cabinet 110 so as to view an area external to vending system 100. For example, external camera 130 may be arranged on a door of vending system 100, on an exterior of cabinet 110, or camera 130 may be separate from vending system 100. In some embodiments, external camera 130 may be activated when a presence of a consumer is detected near the vending system 100. Presence of a consumer may be detected by a proximity sensor 135 (see, e.g., FIG. 2).

External camera 130 may capture images or videos that may be analyzed to determine a visual characteristics and temperature of products 200 removed from cabinet 110, similar to the operation of internal cameras 120. In some embodiments, external camera 130 can be used to identify products and temperature of products as described in method 1000. Thus, a product removed from cabinet 110 may be detected by external cameras 130 to determine a shape, size, or coloring of product 200, as well as temperature of product 200. Data from external camera 130 may be used to confirm the identity of product 200 removed from cabinet 110 as determined by other cameras or sensors described herein.

Embodiments described herein can be used to detect when a consumer is engaged in unauthorized activity. In some embodiments, if the system detects, for example as described related to method 1050, that a product returned to cabinet 110 does not match product 200 removed from cabinet 110, the system can alert third parties (e.g., retail employees, authorities, such as a security personnel, etc.). Further, door 118 of the cabinet 110 can be locked so door 118 cannot be opened and products 200 within cabinet 110 can no longer be accessed by a consumer. In some embodiments, an alarm 178 may be activated if the system detects that the product returned to cabinet 110 does not match product 200 removed from cabinet 110.

In some embodiments, the identity of a product removed from cabinet 110 may be determined using one or more of internal cameras 120, weight sensors 140, optical sensors 160, identifier sensor 150, or external cameras 130 as described herein. While the identity of a product removed from cabinet 110 may be determined based on data from internal cameras 120 and identifier sensor 150, one or more of an optical sensor 160, weight sensor 140, and external camera 130 may be used to confirm that the identity is correct. The additional sensors or cameras may also serve as a back-up in the event that a camera or identifier fails to operate correctly.

In one example of a product identification, a camera may capture an image of the product to identify the shape of a product (e.g., a bottle-shape). However, the shape of the product may correspond to multiple possible product identities (e.g., Pepsi, diet Pepsi, or cherry Pepsi). An identifier sensor may detect an identifier on the product, such as text (e.g., diet Pepsi), which may correspond to multiple product identities (e.g., a can or a bottle). Thus, in combination, the data from the camera and identifier sensor may be analyzed to determine a predicted identity of the product (e.g., a bottle of diet Pepsi). The analysis may limit potential product identifications to products in the product inventory. Additional data may be collected to confirm that the product identification is correct.

In some embodiments, artificial intelligence may determine a confidence level for product identification based on the cameras or sensors. Sensor fusion algorithms may determine the product identity based on the confidence level in the identification made by each camera or sensor. If the data is in agreement, the product identity is confirmed. For example, if a first camera determines a product removed is Product A with 80% confidence, a second camera determines the product removed is Product B with 30% confidence, the algorithm may determine that Product A is the correct product identification due to the higher confidence level. In some embodiments, data from a particular camera or sensor may have a stronger weight in determining the identity. In some embodiments, if the confidence level is below a predetermined threshold, e.g., 30%, the data may be disregarded. In some embodiments, if the confidence level is below a predetermined threshold, an alert may be sent for an audit or review to be conducted.

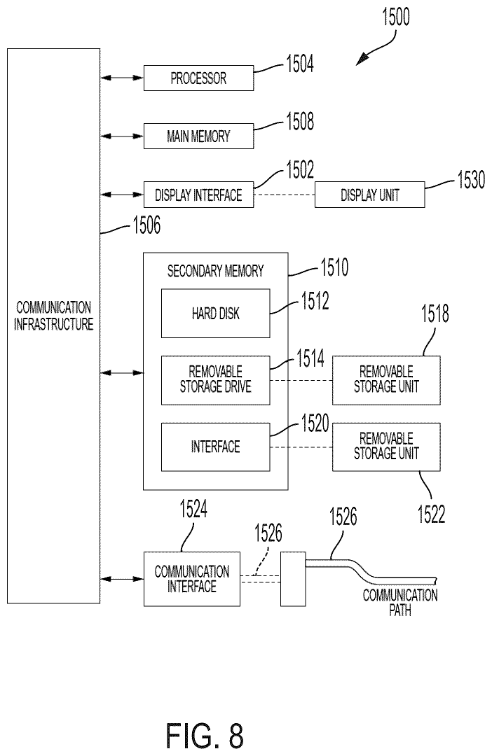

FIG. 8 illustrates an exemplary computer system 1500 in which embodiments, or portions thereof, may be implemented as computer-readable code. Control unit 180 as discussed herein may be computer systems having all or some of the components of computer system 1500 for implementing processes discussed herein.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention(s) may be implemented in terms of this example computer system 1500. After reading this description, it will become apparent to a person skilled in the relevant art how to implement one or more of the invention(s) using other computer systems and/or computer architectures. Although operations may be described as a sequential process, some of the operations may in fact be performed in parallel, concurrently, and/or in a distributed environment, and with program code stored locally or remotely for access by single or multi-processor machines. In some embodiments, edge computing, cloud computing, or a combination thereof may be used. In addition, in some embodiments the order of operations may be rearranged without departing from the spirit of the disclosed subject matter.

Processor device 1504 may be a special purpose or a general purpose processor device. As will be appreciated by persons skilled in the relevant art, processor device 1504 may also be a single processor in a multi-core/multiprocessor system, such system operating alone, or in a cluster of computing devices operating in a cluster or server farm. Processor device 1504 is connected to a communication infrastructure 1506, for example, a bus, message queue, network, or multi-core message-passing scheme.

Computer system 1500 also includes a main memory 1508, for example, random access memory (RAM), and may also include a secondary memory 1510. Secondary memory 1510 may include, for example, a hard disk drive 1512, or removable storage drive 1514. Removable storage drive 1514 may include a floppy disk drive, a magnetic tape drive, an optical disk drive, a flash memory, or the like. The removable storage drive 1514 reads from and/or writes to a removable storage unit 1518 in a well-known manner. Removable storage unit 1518 may include a floppy disk, magnetic tape, optical disk, a universal serial bus (USB) drive, etc. which is read by and written to by removable storage drive 1514. As will be appreciated by persons skilled in the relevant art, removable storage unit 1518 includes a computer usable storage medium having stored therein computer software and/or data.

Computer system 1500 (optionally) includes a display interface 1502 (which can include input and output devices such as keyboards, mice, etc.) that forwards graphics, text, and other data from communication infrastructure 1506 (or from a frame buffer not shown) for display on display unit 1530.

In alternative implementations, secondary memory 1510 may include other similar means for allowing computer programs or other instructions to be loaded into computer system 1500. Such means may include, for example, a removable storage unit 1522 and an interface 1520. Examples of such means may include a program cartridge and cartridge interface (such as that found in video game devices), a removable memory chip (such as an EPROM, or PROM) and associated socket, and other removable storage units 1522 and interfaces 1520 which allow software and data to be transferred from the removable storage unit 1522 to computer system 1500.

Computer system 1500 may also include a communication interface 1524. Communication interface 1524 allows software and data to be transferred between computer system 1500 and external devices. Communication interface 1524 may include a modem, a network interface (such as an Ethernet card), a communication port, a PCMCIA slot and card, or the like. Software and data transferred via communication interface 1524 may be in the form of signals, which may be electronic, electromagnetic, optical, or other signals capable of being received by communication interface 1524. These signals may be provided to communication interface 1524 via a communication path 1526. Communication path 1526 carries signals and may be implemented using wire or cable, fiber optics, a phone line, a cellular phone link, an RF link or other communication channels.

In this document, the terms “computer program medium” and “computer usable medium” are used to generally refer to media such as removable storage unit 1518, removable storage unit 1522, and a hard disk installed in hard disk drive 1512. Computer program medium and computer usable medium may also refer to memories, such as main memory 1508 and secondary memory 1510, which may be memory semiconductors (e.g. DRAMs, etc.).

Computer programs (also called computer control logic) are stored in main memory 1508 and/or secondary memory 1510. Computer programs may also be received via communication interface 1524. Such computer programs, when executed, enable computer system 1500 to implement the embodiments as discussed herein. In particular, the computer programs, when executed, enable processor device 1504 to implement the processes of the embodiments discussed here. Accordingly, such computer programs represent controllers of the computer system 1500. Where the embodiments are implemented using software, the software may be stored in a computer program product and loaded into computer system 1500 using removable storage drive 1514, interface 1520, and hard disk drive 1512, or communication interface 1524.

Embodiments of the invention(s) also may be directed to computer program products comprising software stored on any computer useable medium. Such software, when executed in one or more data processing device, causes a data processing device(s) to operate as described herein. Embodiments of the invention(s) may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

Embodiments described herein can be used to collect data related to inventory levels; number of products sold; types of products sold; times products are sold; locations where specific products are sold; prices at which products are sold; payment methods; user information; instances of unauthorized activity (e.g., a consumer returning a product that does not match a removed product); and/or temperature of the stored products, products removed, and products returned.

Numerous vending systems 100 can incorporate embodiments disclosed herein to create a network of vending systems that can collect data discussed above. This data from individual vending systems and/or from a network of vending systems can be used in a machine learning system. Such a system is described for example in U.S. patent application Ser. No. 18/604,088, filed Mar. 13, 2024, which is incorporated herein by reference in its entirety.

In some embodiments, the machine learning system can be used to ensure items are properly stocked so that retailers to not run out of inventory. In some embodiments, the machine learning system can be used to predict which products will sell and when they will sell. Such tracking can be at a large scale (e.g., the entire network of vending system 100 or a regional network of vending systems) or smaller scale (e.g., vending systems at particular stores or cities). In some embodiments, the machine learning system can be used to track pricing data, inventory levels, and times that products sell to determine the appropriate pricing and inventory levels for various vending systems or networks of vending systems. In some embodiments, the machine learning system can be used to optimize inventories and sales, for example, by learning which products are likely to sell and when, and adjusting inventory levels based on data collected from specific vending systems or from a network of vending systems.

In some embodiments, the machine learning system can be used to adjust temperatures of various vending systems. In some embodiments, the machine learning system can be used to adjust the temperature based on the weather. For example, on warmer days the target temperature for products 200 removed from cabinet 110 may be higher than on cooler days. Moreover, the temperature may be adjusted based on consumer preferences in certain regions.

In some embodiments, the machine learning system can be used to optimize energy consumption of the vending systems. For example, the machine learning system can help modulate the energy use based on different parameters, such as the geographic location, time, specific store, and specific products stored and sold. As an example, the system can learn the times of day when sales of products peak and ensure that the vending system 100 achieves the optimal temperature prior to the peak sales time period. Similarly, the system can learn the times of day when the sales of products are slower, or when a specific store is closed or has few consumers, and can increase the temperature tolerances for that system for that particular time period. For example, as discussed above related to method 1050, the system can notify a user when the temperature of a product removed from a cabinet 110 is greater than a predetermined temperature. In some embodiments, the system can notify a third party (e.g., retailer, supplier, and/or operator) after at least 5 users receive a notification that the temperature of a product removed from cabinet 110 is greater than a predetermined temperature. In some embodiments, the notification to the third party indicates that an operation parameter is not optimized or not functioning properly (e.g., stocking frequency, cooling system operation, door sealing issues, etc.).

In some embodiments, the machine learning system can learn consumer behaviors and adjust the predetermined temperature based on the learned consumer behaviors. For example, in some embodiments, the predetermined temperature is higher at peak sales times. For example, during peak sales times, the door 118 of cabinet 110 will be opened and closed more frequently, which means the vending system 100 will have a harder time maintaining the optimal temperature in cabinet 110. In those situations, the predetermined temperature may be increased to allow for larger differences between the temperature of product 200 and the optimal temperature.

Additionally, the machine learning system can detect equipment or operation issues with the vending systems. For example, the machine learning system can learn typical consumer behaviors, purchase patterns, temperature fluctuations, etc. during normal use. In some embodiments, the machine learning system can determine deviations from the typical conditions and can provide a notification of the deviations. For example, if the system determines that the average temperature of each beverage removed is higher than typical, it can provide a notification to the retailer or supplier. Such a deviation could be an indication that restocking is not completed as intended (i.e., new, unchilled products 200 being placed at the front of the shelf rather than at the back of the shelf) or that there is an equipment issue preventing adequate chilling of the products 200 in cabinet 110.

As used herein, the terms “top” and “bottom” and the like are intended to assist in understanding of embodiments of the disclosure with reference to the accompanying drawings with respect to the orientation of the vending systems and components thereof as shown, and are not intended to be limiting to the scope of the disclosure or to limit the disclosure scope to the embodiments depicted in the Figures. The directional terms are used for convenience of description and it is understood that the vending systems and components thereof may be positioned in any of various orientations.

As used herein, when the term “about” is used in describing a value or an end-point of a range, the disclosure should be understood to include the specific value or end-point referred to. As used herein, the term “about” may include ±10%.

It is to be appreciated that the Detailed Description section, and not any other section, is intended to be used to interpret the claims. Other sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above examples are illustrative, but not limiting, of the present disclosure. Other suitable modifications and adaptations of the variety of conditions and parameters normally encountered in the field, and which would be apparent to those skilled in the art, are within the spirit and scope of the disclosure.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present disclosure should not be limited by any of the above-described exemplary embodiments, but should be defined only in accordance with the claims and their equivalents.

What is claimed is:

1. A method for identifying characteristics of products in a cabinet, the method comprising:
detecting a first characteristic of a first product stored in a storage area of the cabinet, wherein the product storage area is accessible to a consumer via a door, wherein the first characteristic is detected by a camera within the cabinet, wherein the first characteristic comprises a shape of the product, a dimension of the product, or a coloring of the product;
detecting a second characteristic of the first product by the camera, wherein the second characteristic comprises infrared energy;
determining, based on the detected first characteristic, an identity of the product;
determining, based on the detected second characteristic, a temperature of the product.

2. The method of claim 1, wherein the first characteristic and the second characteristic are detected at a first time period corresponding to the product being removed from the storage area.

3. The method of claim 2, further comprising determining the temperature of the product at the first time period.

4. The method of claim 3, further comprising notifying the consumer, on a display of the cabinet, when the temperature of the product at the first time period is greater than a predetermined temperature.

5. The method of claim 3, wherein the first characteristic and the second characteristic are detected at a second time period corresponding to the product being returned to the storage area.

6. The method of claim 3, further comprising:
determining the temperature of the product at the second time period and comparing the temperature at the first time period and temperature at the second time period to determine a difference in temperature.

7. The method of claim 6, further comprising:
notifying the consumer, on a display of the cabinet, when the difference in temperature is greater than 10° C.

8. The method of claim 6, further comprising:
charging the consumer, on a payment processing unit, for the product when the difference in temperature is greater than 10° C.

9. The method of claim 1, wherein the determining the identity of the product comprises comparing the first characteristic to a database of product information.

10. The method of claim 9, further comprising detecting an identifier on the product by an identifier sensor, wherein the determining the identity of the product comprises comparing the identifier to the database of product information.

11. The method of claim 1, further comprising using machine learning to assign a confidence level to the determining the identity of the product.

12. A vending system, comprising:
a cabinet comprising a storage area for storing products, and a door coupled to the cabinet, wherein the door is movable between a closed configuration and an open configuration in which the products are accessible to a consumer;
a camera arranged within the cabinet and configured to detect characteristics of a product, wherein the characteristics comprise a first characteristic and a second characteristic,
wherein the first characteristic comprises a visual characteristic of the product, and
wherein the second characteristic comprises infrared energy;
a control unit in communication with the camera,
wherein the control unit is configured to determine an identity of the product based on the first characteristic, and
wherein the control unit is configured to determine a temperature of the product based on the second characteristic.

13. The vending system of claim 12, wherein the visual characteristic comprises a shape of the product, a dimension of the product, or a coloring of the product.

14. The vending system of claim 12, wherein the camera is configured to detect the first and second characteristics of the product during a first time period to determine the identity of the product and the temperature of the product, wherein the first time period corresponds to the product being removed from the cabinet.

15. The vending system of claim 14, wherein the camera is configured to detect the first and second characteristics during a second time period to determine the identity of the product and the temperature of the product, wherein the second time period corresponds to the product being returned to the cabinet.

16. The vending system of claim 14, wherein the control unit is configured to determine a price of the product based on the identity of the product and the temperature of product during the first time period.

17. The vending system of claim 15, wherein the control unit is configured to compare the detected visual characteristics at the first time period to the detected visual characteristics at the second time period.

18. The vending system of claim 15, wherein the camera is configured to detect infrared energy at the first time period and at the second time period, and
wherein the control unit is configured to determine the temperature of the product at the first time period and at the second time period.

19. The vending system of claim 18, wherein the control unit is configured to determine, based at least in part on a comparison of the temperature at the first time period and the temperature at the second time period, whether the product being returned matches the product being removed.

20. The vending system of claim 12, wherein the control unit is configured to determine the identity of the product based at least in part on a comparison of the visual characteristic to a database of product information.

21. The vending system of claim 12, further comprising an identifier sensor configured to detect an identifier of the product, wherein the control unit is configured to determine the identity of the product based at least in part on a comparison of the identifier to a database of product information.

22. The vending system of claim 12, further comprising a plurality of cameras, wherein each camera of the plurality of cameras is configured to detect the visual characteristics, and wherein each camera of the plurality of cameras is configured to detect the infrared energy.

23. The vending system of claim 12, wherein the camera is configured to detect the infrared energy when the door is in the closed configuration.

24. The vending system of claim 12, wherein the camera is an RGB-IR camera.

25. The vending system of claim 12, further comprising a lock configured to lock the door in the closed configuration, wherein the control unit is configured to lock the lock in response to a determination that a temperature of the product is greater than 5° C.
